(19) United States
(12) Patent Application Publication
(10) Pub. No.: US 2004/0103000 A1
(43) Pub. Date: May 27, 2004

(54) Portable system and method for health information storage, retrieval, and management

(76) Inventors: Fori Owurowa, Redondo Beach, CA (US); Paula Comensky, Redondo Beach, CA (US)

Correspondence Address: FREDERICK W. GIBB, III, MCGINN & GIBB, PLLC, 2568-A RIVA ROAD, SUITE 304, ANNAPOLIS, MD, 21401, US

(21) Appl. No.: 10/305,206

(22) Filed: Nov. 26, 2002

(51) Int. Cl. G06F 17/60; H04K 1/00; H04L 9/00

(52) U.S. Cl. 705/2; 705/50

(57) ABSTRACT

A system and method of managing medical data, wherein the method comprises attaching a portable medical data storage unit device to a data processing system through a universal serial bus port interface, wherein the portable medical data storage unit device stores the data; reading the data on the data processing system; decrypting the data on the data processing system; classifying the data into a plurality of data fields; entering additional data into the data processing system; encrypting the data; and transferring the additional data stored in the data processing system to the portable medical data storage unit device. The data fields are selectively segmented according to patient data, medical history data, alerts and medications data, notes data, and images data. Also, the data comprises images, wherein the images comprise photographic, x-ray, graphical, text, and color images.

### BACKGROUND OF THE INVENTION

1. Field of the Invention

The present invention generally relates to medical data storage systems and methods, and more particularly to a health information management computer system performing a method of managing medical data.

2. Description of the Related Art

Personal medical information is typically stored in a centralized database for retrieval by healthcare providers. Various storage systems and methods have been disclosed for storing personal medical information on portable data cards, such as credit card-like data cards containing a data chip and magnetic strip cards, or on health watches, such as the type disclosed in U.S. Pat. No. 5,337,290 issued to Ventimiglia et al. However, the drawbacks of the conventional devices are that they are not very durable because they are as thin as a credit card and can easily bend, break, be stolen, or damaged in any way.

Moreover, the amount of information stored in such devices is often limited, and they often require a special separately purchased reader device, often expensive, to read the data that is stored. Furthermore, such conventional storage devices are not universal. That is, the data can only be used at a particular hospital or doctor's office, and cannot be accessed everywhere. This is often a problem associated with the read device, as several types exist, which are non-compatible with the conventional storage devices. Another problem with the conventional storage devices is their inability to update data in a quick and efficient manner. In fact, some conventional devices simply fail to record data, thereby potentially causing serious deleterious effects to the patient.

These various card-like technologies are competing for industry-wide acceptance because a broad acceptance is necessary for their success. This is because these conventional systems depend upon the special electronic data reader equipment which must be installed in all locations. Unfortunately, the specialized, complex, and expensive hardware and software required to allow these cards to function make these solutions unattractive and prone to errors.

Medical treatment is provided at a variety of locations, including offices of physicians, specialists, pharmacies, clinics, hospitals, nursing homes, schools, homes, and in ambulances (or elsewhere) by emergency medical technicians. The volume and scope of medical data attributed to a particular individual is expansive, and when past data is necessary for proper treatment, it must be retrievable quickly, efficiently, safely, and without errors. Moreover, whether in emergency situations or simple routine check ups at a physician's office, such data is preferably retrievable at a moment's notice. However, when an individual, during the course of his/her life accumulates vast amounts of data stored at several different locations (i.e., having his/her medical files at several different physicians' offices, clinics, hospitals, pharmacies, etc.), it has been impossible to retrieve all such data at a moment's notice. Even when data is available, it is primarily in the form of paper-based charts containing often illegible handwritten notes, test results, evaluations, insurance information, drug interaction summaries, and laboratory test images etc., which may be outdated or worse not attributable to the patient at all (i.e., misplaced in the patient's file from another patient's file).

The difficulty of storing, retrieving, reviewing, analyzing, and communicating vital information quickly from these documents is a very serious problem. A proper portable medical record system must also ensure confidentiality and privacy of the stored information. This factor precludes the use of central computer database systems which store private medical records. Moreover, those individuals who need access to such records often require a special identification code for access. In emergency situations, this extra step may be the difference between life and death. In fact, those needing access to personal medical information, such as emergency medical technicians, must not be restricted to single points of access, i.e., to central mainframe repositories of records. Rather, personal medical information must be available via widely distributed access points throughout the world.

Therefore, there remains a need for a portable medical data storage device operable in a medical data retrieval information system, which is durable and can be kept by the patient at all times, thereby allowing access to the patient's medical data in either routine or emergency situations.

### SUMMARY OF THE INVENTION

The present invention has been devised to provide an automated system and method for a health information management system. Specifically, the present invention provides a computer information management system that repurposes a universal serial bus (USB) device to quickly store and retrieve personal, social, and medical data for quick use in medical treatment and hospital admittance by reducing handwritten forms, streamlining conflict checking procedures at pharmacies, and providing a method for people to carry their latest medical and personal data with them easily and safely such that the stored data remains intact.

There is provided, according to one aspect of the invention, a health information management system comprising a data storage component operable for storing data fields, wherein the data fields are readable and writeable by a user; a universal serial bus port; an interface connected to the universal serial bus port; a portable housing unit adapted to house the data storage component and the universal serial bus port; connecting means configured on the housing unit for attaching to an external receptor; and display means connected to the interface for displaying the data fields into a readable format for the user. The data fields comprise data, which further comprise patient information, medical history information, alerts and medications information, notes information, and image information fields. Moreover, the housing unit is flame retardant and water resistant. Additionally, the data comprises images, which further comprise photographic, x-ray, graphical, text, and color images.

Alternatively, there is provided a health information management system comprising storage means for storing data fields, wherein the data fields are readable and writeable by a user; interface means for transmitting the data fields to a display mechanism; a portable housing unit adapted to house the storage means and the interface means; and connecting means configured on the housing unit for attaching to an external receptor, wherein the display mechanism receives the data fields from the interface means, and wherein the display mechanism is operable to display the data fields into a readable format for the user.

The present invention further provides a method of managing medical data, wherein the method comprises attaching a portable medical data storage unit device to a data processing system through a universal serial bus port interface, wherein the portable medical data storage unit device stores the data; reading the data on the data processing system; decrypting the data on the data processing system; classifying the data into a plurality of data fields; entering additional data into the data processing system; encrypting the data; and transferring the additional data stored in the data processing system to the portable medical data storage unit device. Additionally, the data fields are selectively segmented according to patient data, medical history data, alerts and medications data, notes data, and images data. Also, the portable medical data storage unit device comprises a data storage component operable for storing the data fields, wherein the data fields are readable and writeable by a user; a universal serial bus port; a housing unit adapted to house the data storage component and the universal serial bus port; and connecting means configured on the housing unit for attaching to an external receptor. Furthermore, the data comprises images, which comprise photographic, x-ray, graphical, text, and color images. The method further comprises sending an authorization and/or verification inquiry to an external information system, such as an insurance company and receiving one of a positive and negative response from the external information system. Also, the present invention provides a program storage device readable by machine, tangibly embodying a program of instructions executable by the machine to perform a method of managing medical data.

There are several benefits of the present invention. First, the storage device of the present invention is small, easily portable, made of durable, water resistant, and flame retardant material, and is capable of storing, retrieving, and updating the data stored therein. Second, the present invention is organized in a simple manner by a series of data fields. Third, the present invention utilizes a universal serial bus port to communicate the data to a computer terminal or other display means, thereby requiring no specialized and expensive data reader devices. Moreover, the present invention allows patients to carry more complete sets of their medical data with them, including information relating to their allergies, medications currently taken, blood type, as well as data images including x-rays, etc.

Another benefit of the present invention is it overcomes the previous slow and costly processes of admitting patients to hospitals due to the time necessary to fill out large forms requiring significant data entry. The present invention does this by having all of the required information, including health insurance information, stored in the device, and immediately retrievable. Furthermore, the manner in which the present invention stores data eliminates the need for entering redundant entries of personal information, such as name, address, insurance information, etc. by a user and/or patient every time he/she is seen by a health care provider. Moreover, the present invention provides a communications link to insurance providers, thereby allowing for quick, almost immediate (depending on the sophistication of the insurance provider's information data system), authorization and verification of the patient's insurance coverage. The present invention also overcomes problems with non-English speaking individuals, wherein conventionally, extracting medical information from such patients often results in miscommunications, and possible misdiagnosis. The present invention provides for a constant up to date medical data record and is universally accessible in any geographic location having access to display means for running software, such as a computer terminal, a personal digital assistant (PDA), etc.

Furthermore, the present invention enlarges the scope of those medical practitioners needing access to full medical data records, such as dentists, pharmacists, emergency medical technicians, and clinicians. Moreover, the data stored in the present invention can be universally formatted to different healthcare providers' existing internal software, thereby negating the need to revamp already established systems. Additionally, the present invention provides for a security feature which allows personal and private information to be accessed only by authorized users, without compromising the administration of proper treatment to the patient, especially in emergency situations.

### BRIEF DESCRIPTION OF THE DRAWINGS

The invention will be better understood from the following detailed description of a preferred embodiment(s) of the invention with reference to the drawings, in which:

FIG. 1 is a system diagram according to the present invention;

FIG. 2 is a schematic diagram of a portable medical data storage unit device according to the present invention;

FIG. 3 is a schematic diagram of a portable medical data storage unit device according to the present invention;

FIG. 4 is a flow diagram illustrating a preferred method of the present invention;

FIG. 5 is a flow diagram illustrating a preferred method of the present invention;

FIG. 6 is a graphical illustration of an arrangement of data stored in the portable medical data storage unit device according to the present invention;

FIG. 7 is a graphical illustration of an arrangement of data stored in the portable medical data storage unit device according to the present invention;

FIG. 8 is a graphical illustration of an arrangement of data stored in the portable medical data storage unit device according to the present invention;

FIG. 9 is a graphical illustration of an arrangement of data stored in the portable medical data storage unit device according to the present invention;

FIG. 10 is a graphical illustration of an arrangement of data stored in the portable medical data storage unit device according to the present invention; and

FIG. 11 is a system diagram according to the present invention.

### DETAILED DESCRIPTION OF PREFERRED EMBODIMENTS OF THE INVENTION

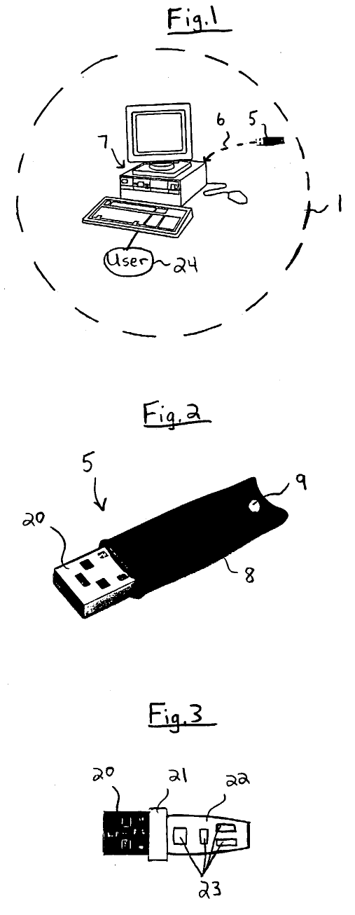

As previously mentioned, there is a need for a new health information management computer system performing a method of managing medical data. The present invention provides for quick storage and retrieval of personal, social, and medical data for use in medical treatment and in quick hospital admittance by reducing handwritten forms, reducing conflict checking procedures at pharmacies, and providing a new way for people to carry their medical data with them, including personal information relating to credit card numbers. Referring now to the drawings, and more particularly to FIGS. 1 through 11, there are shown preferred embodiments of the system and method according to the present invention.

FIGS. 1 through 3 illustrate a health information management system 1 comprising a data storage component 22 operable for storing data fields, wherein the data fields are readable and writeable by a user 24; a universal serial bus port 20; an interface 6 connected to the universal serial bus port 20; a portable housing unit 8 adapted to house the data storage component 22 and the universal serial bus port 20; connecting means 9 configured on the housing unit 8 for attaching to an external receptor (not shown); and display means 7 connected to the interface 6, wherein the display means 7 may comprise a computer terminal, PDA device, or any other computer display mechanism, and wherein the display means 7 is operable to display the data fields into a readable format for the user 24. The portable housing unit 8 together with the USB port connector 20, the connecting means 9, and the data storage component 22 comprise a portable storage unit 5, which a patient can carry with him/her. This portable storage unit 5 is generally the size of a key, and the housing unit 8 is comprised of a durable, water resistant, flame retardant material. The connecting means 9 comprises a hole, groove, notch, or any other connecting mechanism, which allows the portable storage unit 5 to be connected to an external receptor (not shown), such as someone's keychain, for example. Furthermore, the portable storage unit 5 may comprise a unit such as those available from Aladdin Knowledge Systems, IL, USA.

FIG. 3 illustrates the device 5 without the housing unit 8 attached, wherein the data storage component 22 is visible including memory elements 23. The USB port 20 plugs into a corresponding interface 6, which may comprise a cable, or other such interface means having a USB plug on one side, and a USB connector on the other side, which is then connected to a computer 7 having a similar USB connector to receive the USB plug of the interface 6. The data storage component 22 may comprise a typical memory array chip 23, which is known in the art. The data storage component 22 provides full RSA 1,024-bit key encryption, as well as 3×DES 168-bit encryption and SHA-1 message digesting.

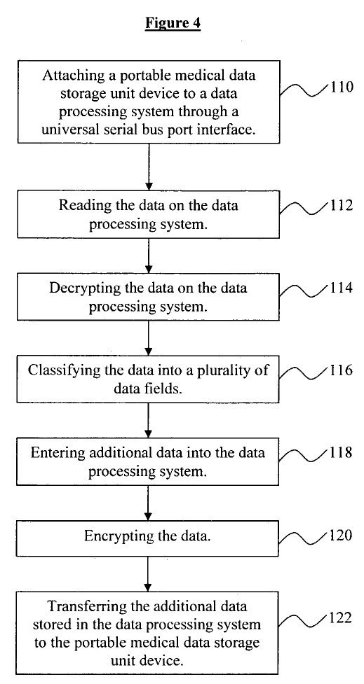

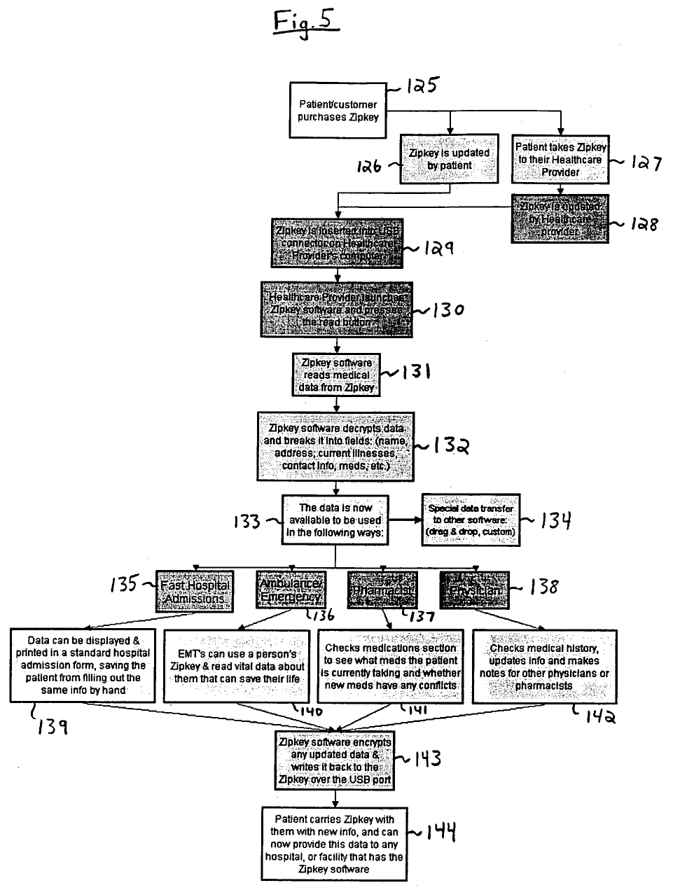

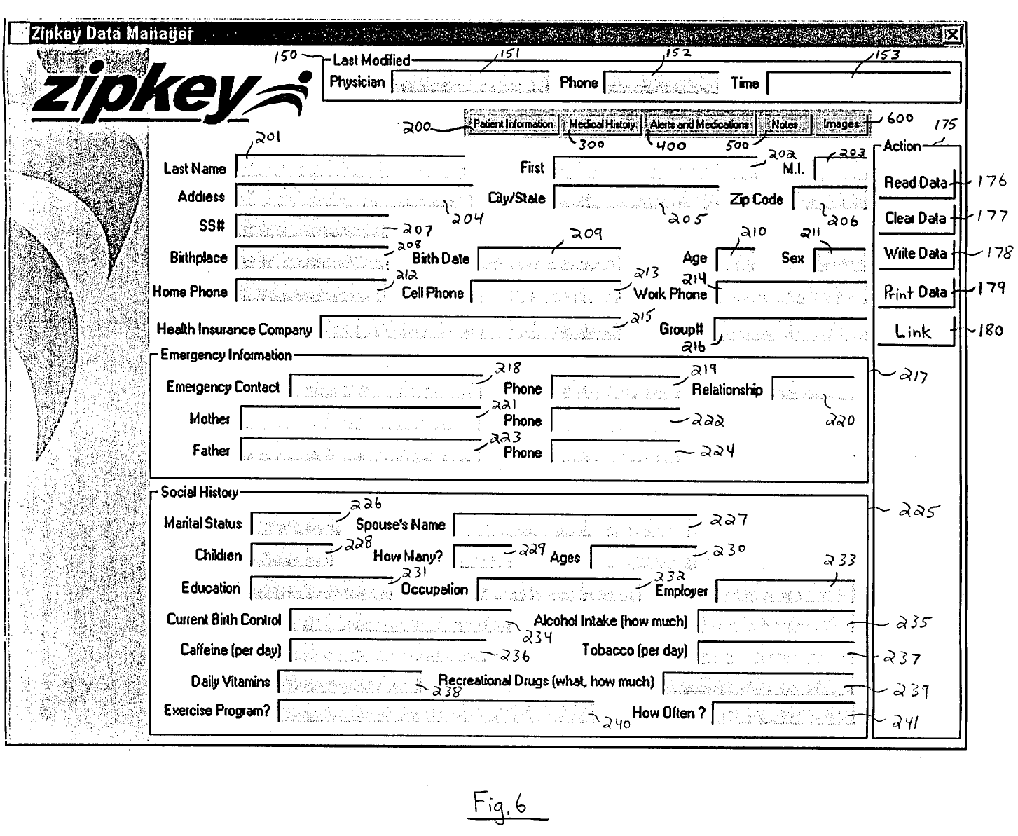

The present invention further provides a method of managing medical data, which is illustrated in the flow diagram of FIG. 4, wherein the method comprises attaching 110 a portable medical data storage unit device to a data processing system 7 through a universal serial bus port interface 20, wherein the portable medical data storage unit device 5 stores the data; reading 112 the data on the data processing system 7; decrypting 114 the data on the data processing system 7; classifying 116 the data into a plurality of data fields; entering 118 additional data into the data processing system 7; encrypting 120 the data; and transferring 122 the additional data stored in the data processing system 7 to the portable medical data storage unit device 5.

Additionally, the data fields are selectively segmented according to patient data 200, medical history data 300, alerts and medications data 400, notes data 500, and images data 600 further shown in FIGS. 6 through 10. Also, the portable medical data storage unit device 5 comprises a data storage component 22 operable for storing the data fields, wherein the data fields are readable and writeable by a user 24; a universal serial bus port 20; a housing unit 8 adapted to house the data storage component 22 and the universal serial bus port 20; and connecting means 9 configured on the housing unit 8 for attaching to an external receptor (not shown). Furthermore, the data comprises images, which comprise photographic, x-ray, graphical, text, and color images. The images are stored in any conventional format known in the art such as jpg, gif, tiff, bmp files, etc. The method further comprises sending an authorization and/or verification inquiry to an external information system, such as an insurance company and receiving one of a positive and negative response from the external information system. This is beneficial because the insurance company can authorize and verify that a particular patient is covered through his/her insurance policy to have the respective procedures, tests, drugs, etc. administered.

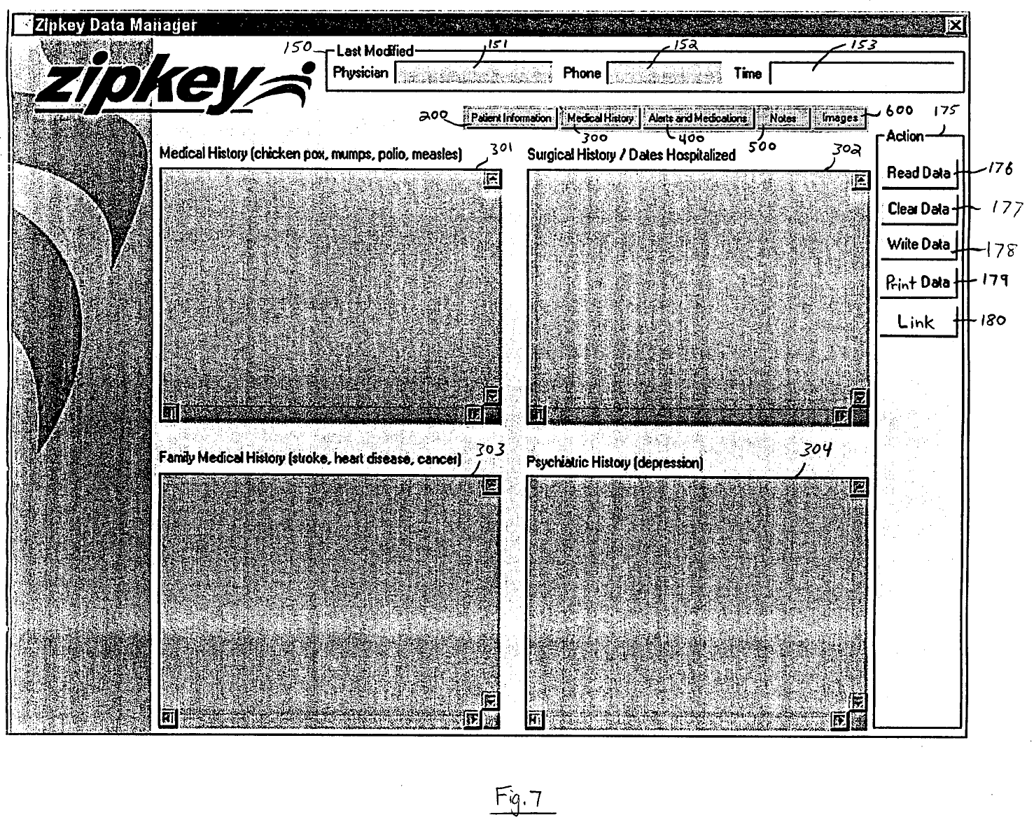

FIG. 5 illustrates the methodology in which the present invention is practiced. The present invention is embodied as a Zipkey™ system available from Zipteck, LLC, CA, USA, and is referred to as such in the flow diagram of FIG. 5, along with the screen shots shown in FIGS. 6 through 10. In FIG. 5, the process begins with a patient/customer purchasing 125 the portable medical data storage unit device 5. Then, the Zipkey™ system is updated 126 by the patient and/or the portable medical data storage unit device 5 is taken 127 to the patient's healthcare provider to be updated 128. Next, the portable medical data storage unit device 5 is inserted 129 to the USB interface 6 connector on the healthcare provider's computer 7.

Thereafter, the healthcare provider launches 130 the accompanying Zipkey™ software and presses the Read button 176. Next, the Zipkey™ software, which is loaded on the computer 7, reads 131 the medical data from the portable medical data storage unit device 5. After this, the Zipkey™ software decrypts 132 the data and breaks it into several data fields (including information such as name, address, current illnesses, contact information, medications, etc.).

The data is available 133 to be used in several different ways. First, the data may be transferred 134 to other software (healthcare provider's software) using a special data transfer mechanism (drag & drop, customized, etc.). Alternatively, the data is available to be used for fast hospital admissions 135, where the data can be displayed and printed 139 in a standard hospital admission form, thereby saving the patient/hospital staff the time from filling out the same information by hand. Also, the data is available to be used in an emergency (i.e., by emergency medical technicians in an ambulance) 136, wherein emergency medical technicians (EMTs) can use 140 a patient's portable medical data storage unit device 5 and read vital data about the patient, which can aide the EMTs in saving the patient's life.

Additionally, the data is available to be used by a pharmacist 137, who can check 141 the medications section 400 to see what medications the patient is currently taking and whether new medications have any conflicts. Moreover, the data is available to be used by a physician 138, who can check 142 the medical history updates 300 information and make notes for other physicians or pharmacists. Of course, the data is available to be used by a variety of medical practitioners including dentists, laboratory clinicians, specialists, clinics, nursing homes, schools, homes, and other medical personnel.

Once the data is accessed, the Zipkey™ software encrypts 143 any updated data and writes it back to the Zipkey™ software and then onto the data storage component 22 of the portable medical data storage unit device 5 over the USB port 20. Finally, the patient carries 144 the portable medical data storage unit device 5 with them with the new updated data and information, and can now provide this data to any hospital, physician, or facility.

The present invention provides a security feature to allow access to all data. The security feature is preferably embodied as a code-encrypted log-on mechanism, which, for example, utilizes a person's social security number, birth date, or any other PIN number as a personal code for logging onto the Zipkey™ system to retrieve the secured data. Preferably, the SS# (social security number) block 207 and/or the Birth Date block 209 in the Patient Information 200 screen are used as the means for logging onto the software. Until a valid code is entered, the remaining data fields in the Patient Information 200 screen remain blocked out or blank. In an emergency situation, where a patient may or may not be able to communicate his/her personal code to a health care provider, the conventional systems do not allow access to any of the stored data, and the patient's life may be at risk as a result. However, according to the present invention the data stored in the Alerts and Medications field 400 are retrievable even without entering the patient's personal code because such information contains the vital data, which may be necessary in emergency situations, such as any potential reactions to medications and current illnesses, blood type, and primary care physician information. However, because the identifying data related to the patient, (i.e., patient's name, address, phone number, social security number, etc.) are not divulged, in the event a patient's portable medical data storage unit device 5 is lost, stolen, or in any way is used by an unauthorized user, a patient's identity will never be compromised, and the data which is available (potential reactions to medications and current illnesses, blood type, and primary care physician information, etc.) will not compromise a patient's privacy, as there is no association to a particular individual. That is, the unauthorized user will simply know that a hypothetical patient is allergic to a particular medication, has a particular allergy or illness, and has a particular blood type, etc. However, the unauthorized user will not know the name or identity of the person who possesses such characteristics.

In FIG. 6, the Patient Information 200 screen shot is illustrated, which comprises several readable/writeable data fields including a Last Modified section 150 comprising an area for the Physician's name 151 (or other healthcare provider's identifying information), the Physician's phone number 152, and Time 153 when the data was entered. An Action component 175 of the software provides for a plurality of modes of data manipulation, including data entry, editing, printing, and communication, among others. For example, the Action component 175 comprises a Read Data button 176, which allows a user 24 to read the data currently stored; a Clear Data button 177, which allows a user 24 to clear the data entered; a Write Data button 178, which allows the data to be written into the software (i.e., saved) upon being entered and verified for accuracy by the user 24; a Print Data button 179, which allows the data on a particular screen to be printed; and a Link button 180, which allows the data to be sent to an external information system (not shown) for authorization and verification purposes. For example, the Link button 180 may send an inquiry to an insurance provider seeking immediate authorization and verification that a particular patient is covered through his/her insurance policy to have the respective procedures, tests, drugs, etc. administered. A corresponding positive or negative response is transmitted from the external information system (not shown) and communicated back to the Zipkey™ software, which then indicates whether the insurance provider has authorized a procedure, etc., or has verified that the patient is in fact covered by the insurance provider's policy. This is beneficial as it significantly reduces the time spent in submitting insurance claims, receiving authorization and verification, etc., thereby eliminating much of the back and forth communication necessary for such authorization and verification procedures inherent in the conventional systems.

The Action buttons 175, Last Modified entries 150, and general data field tabs (Patient Information 200, Medical History 300, Alerts and Medications 400, Notes 500, and Images 600) are shown on all screen shots for the several data fields (as further illustrated in FIGS. 7 through 10), thereby allowing the user 24 the ability to constantly transition from data field to data field (i.e., screen to screen) in a seamless and easy manner.

The Patient Information 200 data field further comprises readable/writeable entries for the patient's Last Name 201, First Name 202, and M.I. (middle initial) 203, as well as the patient's Address 204, City/State 205, Zip Code 206, SS# (social security number) 207, Birthplace 208, Birth Date 209, Age 210, Sex 211, Home Phone 212, Cell Phone 213, Work Phone 214, Health Insurance Company 215, and Group # (Health Insurance Policy Group #) 216. All of these entries collectively provide identifying information regarding the patient.

Additionally, an Emergency Information section 217 is included comprising readable/writeable entries relating to an Emergency Contact 218 and Phone number 219, as well as the Relationship 220 to the patient. Furthermore, the Emergency Information section 217 includes readable/writeable entries relating to the patient's Mother's and Father's name 221, 223, respectively, along with their corresponding telephone numbers 222, 224, respectively. This feature of the present invention is ideal especially if the patient is a minor or of diminished capacity. All of these entries collectively provide emergency contact information regarding the patient.

Next, a Social History section 225 is shown, which includes readable/writeable entries relating to the patient's Marital Status 226, Spouse's Name 227, Children 228, including the number of children (How Many?) 229, and their respective Ages 230. Further entries for the patient's Education 231, Occupation 232, Employer 233 is included, as well as entries for the patient's Current mode of Birth Control 234, Alcohol Intake (how much) 235, Caffeine (per day) 236, Tobacco (per day) 237, Daily Vitamins 238 taken by the patient, Recreational Drugs if taken by the patient (what and how much) 239, and whether the patient is on an Exercise Program 240 and How Often (does the patient exercise) 241. All of these entries collectively provide information regarding the patient's lifestyle.

Next, as illustrated in the screen shot of FIG. 7, the Medical History 300 data fields are presented. Here, data pertaining to the patient's history of illnesses, hospitalization, family histories, etc. are stored. For example, there are included readable/writeable entries pertaining to the patient's Medical History 301, which may include information of past illnesses such as chicken pox, mumps, polio, measles, etc. Next, there is a Surgical History block 302, which includes information pertaining to dates of hospitalization. A further entry allows data to be stored relating to a patient's Family Medical History 303, including information such as family histories of stroke, heart disease, cancer, etc. Finally, a Psychiatric History 304 block is provided, which may detail information pertaining to the patient's psychosis, such as depression.

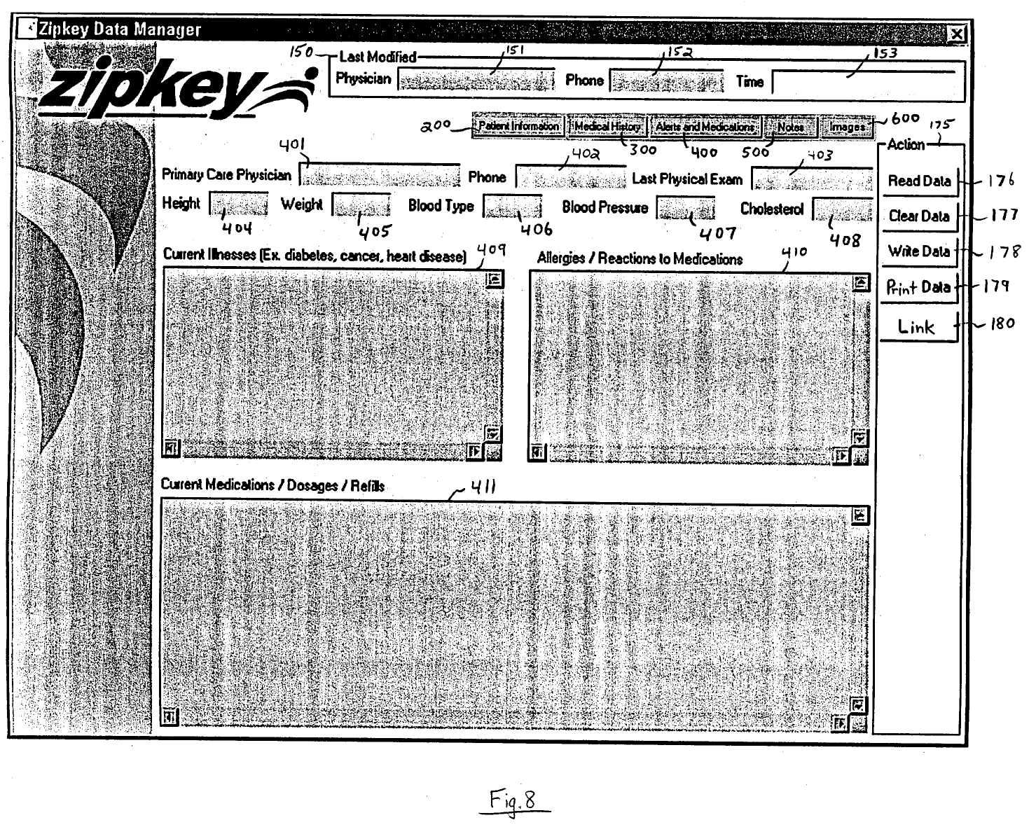

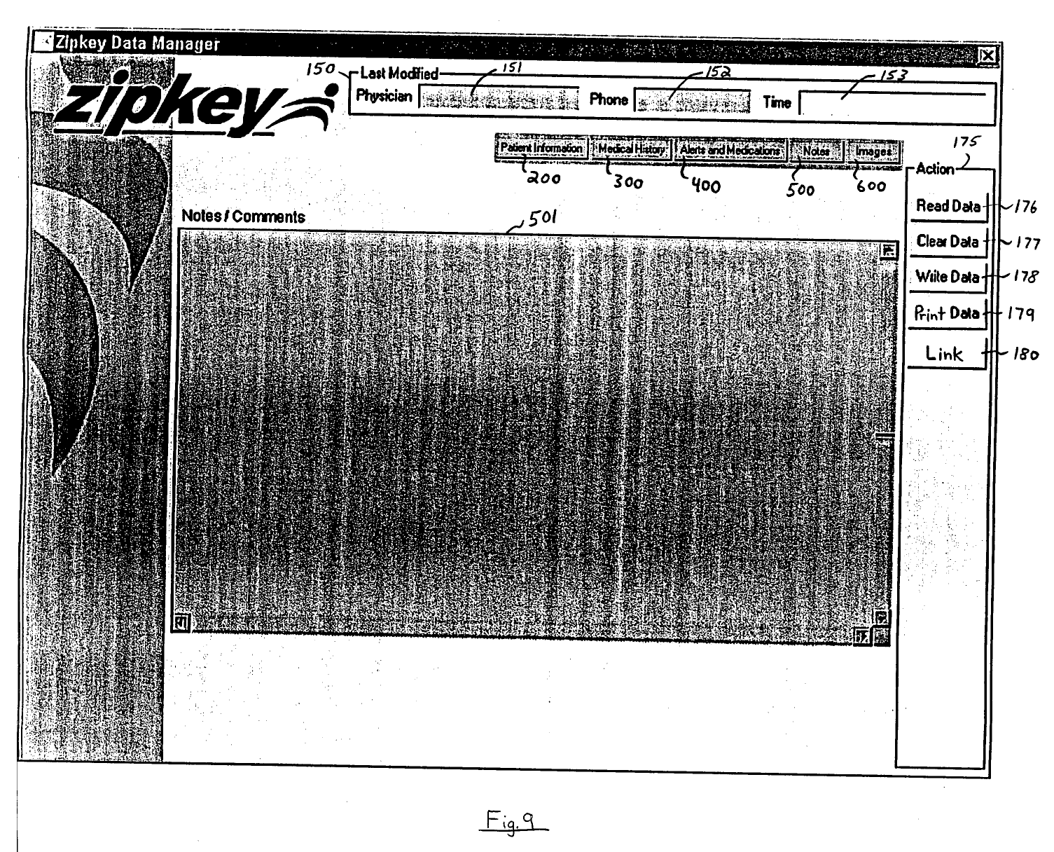

FIG. 8 illustrates the Alerts and Medications 400 screen shot, which includes readable/writeable entries relating to the patient's Primary Care Physician 401, including his/her Phone number 402, and the date of the patient's Last Physical Examination 403. Other information pertaining to the patient such as the patient's Height 404, Weight 405, Blood Type 406, Blood Pressure 407, and Cholesterol level 408 are included as readable/writeable entry blocks as well. Furthermore, an entry block which includes all Current Illnesses 409, which the patient is suffering from, is included, for example diabetes, cancer, heart disease, etc. An Allergies/Reactions to Medications 410 entry block is also provided which can allow a physician to include information vital to a pharmacist's drug interaction inquiry/procedures upon filling prescriptions. Finally, a Current Medications block 411 including information pertaining to dosages and refills is shown. All of these entries collectively provide further identifying information pertaining to the patient's current medical state.

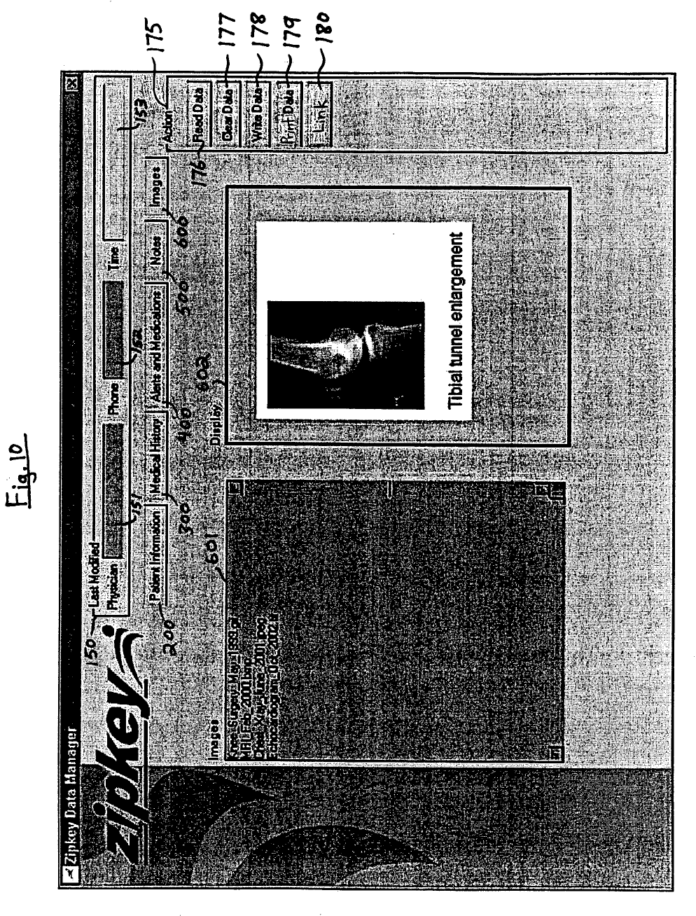

In FIG. 9, a Notes section 500 is shown which provides a general Notes/Comments readable/writeable entry block 501, which can be used as a running ledger and means for communication between an EMT and physician and nurse and pharmacist, etc. It serves to allow for the entry of any additional information, which may aid in the treatment of a patient, or otherwise. This Notes section 500 provides a running list of comments, which may be accessed in the future to verify a particular course of treatment pertaining to the patient, etc.

In FIG. 10, an Images section 600 is shown which provides an Images file name readable/writeable entry block 601. The Images file entry block 601 provides a list of all images saved in the Zipkey™ software, wherein the files may be saved in any conventional format known in the art such as jpg, gif, tiff files, bmp, etc. As a particular file name is selected by a user 24, the corresponding image is displayed in the Display block 602, wherein the images comprise photographic, x-ray, graphical, text, color images, and any other images.

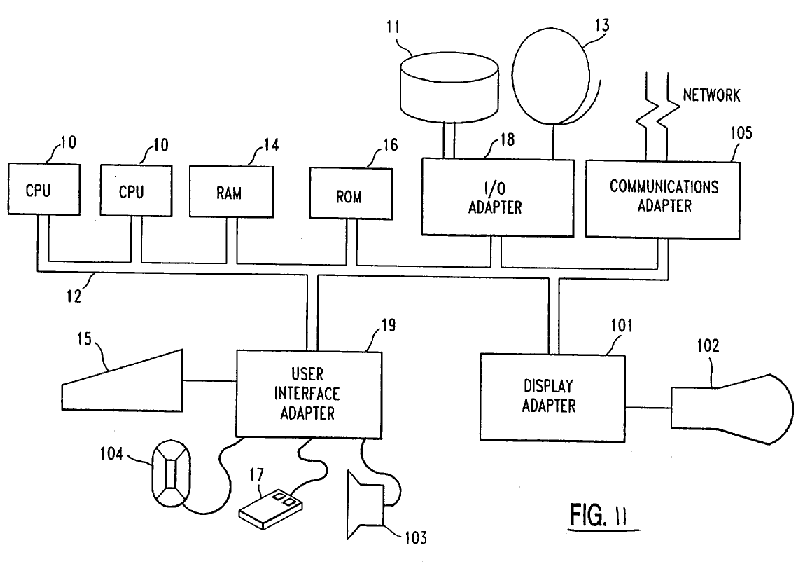

A representative hardware environment for practicing the present invention is depicted in FIG. 11 which illustrates a typical hardware configuration of an information handling/computer system 1 in accordance with the present invention, having at least one processor or central processing unit (CPU) 10. The CPUs 10 are interconnected via system bus 12 to random access memory (RAM) 14, read-only memory (ROM) 16, an input/output (I/O) adapter 18 for connecting peripheral devices, such as disk units 11 and tape drives 13, to bus 12, user interface adapter 19 for connecting keyboard 15, mouse 17, speaker 103, microphone 104, and/or other user interface devices such as a touch screen device (not shown) to bus 12, communication adapter 105 for connecting the information handling system to a data processing network, and display adapter 101 for connecting bus 12 to display device 102. A program storage device readable by the disk or tape units is used to load the instructions, which operate the invention, which is loaded onto the computer system 1.

In an alternative embodiment, the present invention may store multiple credit card numbers and other personal information, and can be used as an alternative to carrying multiple credit cards around, thereby providing a more secure method of purchasing and ordering (both in person and online), as the housing unit 8 of the present invention does not display any credit card numbers or other personal information on its external surface. Moreover, access to such information is also subject to the security mechanism previously described, which requires a personal access code.

The present invention can use any type of storage device that allows universal access on computers or computing devices, such as infrared transmission (such as onto PDAs), “blue tooth” or the like, radio frequency transmission, or any other standard similar to a USB. Other applications of the present invention include providing a universal way of filling out applications electronically, or any forms where standard redundant information must be given and would ordinarily have to be rewritten by hand. As mentioned, by connecting the present invention's abilities to online merchants and credit card providers, it can be used to store multiple credit card numbers and customer information to provide a way to purchase items online or in person, securely without the user having to carry multiple credit cards around.

The present invention may also include several other data fields not specifically discussed above. Such information may include anything related to the patient, which may aid in his/her treatment, as well as include elements pertaining to other non-medically related information such as credit card numbers, etc.

There are several benefits of the present invention. First, the storage device of the present invention is small, easily portable, made of durable, water resistant, and flame retardant material, and is capable of storing, retrieving, and updating the data stored therein. Second, the present invention is organized in a simple manner by a series of data fields. Third, the present invention utilizes a universal serial bus port to communicate the data to a computer terminal or other display means, thereby requiring no specialized and expensive data reader devices. Moreover, the present invention allows patients to carry more complete sets of their medical data with them, including information relating to their allergies, medications currently taken, blood type, as well as data images including x-rays, etc.

Another benefit of the present invention is it overcomes the previous slow and costly processes of admitting patients to hospitals due to the time necessary to fill out large forms requiring significant data entry. The present invention does this by having all of the required information, including health insurance information, stored in the device, and immediately retrievable. Furthermore, the manner in which the present invention stores data eliminates the need for entering redundant entries of personal information, such as name, address, insurance information, etc. by a user and/or patient every time he/she is seen by a health care provider. Moreover, the present invention provides a communications link to insurance providers, thereby allowing for quick, almost immediate (depending on the sophistication of the insurance provider's information data system), authorization and verification of the patient's insurance coverage. The present invention also overcomes problems with non-English speaking individuals, wherein conventionally, extracting medical information from such patients often results in miscommunications, and possible misdiagnosis. The present invention provides for a constant up to date medical data record and is universally accessible in any geographic location having access to display means for running software, such as a computer terminal, a personal digital assistant (PDA), etc.

Furthermore, the present invention enlarges the scope of those medical practitioners needing access to full medical data records, such as dentists, pharmacists, emergency medical technicians, and clinicians. Moreover, the data stored in the present invention can be universally formatted to different healthcare providers' existing internal software, thereby negating the need to revamp already established systems. Additionally, the present invention provides for a security feature which allows personal and private information to be accessed only by authorized users, without compromising the administration of proper treatment to the patient, especially in emergency situations.

While the invention has been described in terms of preferred embodiments, those skilled in the art will recognize that the invention can be practiced with modification within the spirit and scope of the appended claims.

What is claimed is:

1. A health information management system comprising:
a data storage component operable for storing data fields, wherein said data fields are readable and writeable by a user;
a universal serial bus port;
an interface connected to said universal serial bus port;
a portable housing unit adapted to house said data storage component and said universal serial bus port;
connecting means configured on said housing unit for attaching to an external receptor; and
display means connected to said interface for displaying said data fields into a readable format for said user.

2. The system of claim 1, wherein said data fields comprise data further comprising patient information, medical history information, alerts and medications information, notes information, and images information fields.

3. The system of claim 1, wherein said housing unit is flame retardant.

4. The system of claim 1, wherein said housing unit is water resistant.

5. The system of claim 2, wherein said data comprises images.

6. The system of claim 5, wherein said images comprise photographic, x-ray, graphical, text, and color images.

7. A method of managing medical data, said method comprising:
attaching a portable medical data storage unit device to a data processing system through a universal serial bus port interface, wherein said portable medical data storage unit device stores said data;
reading said data on said data processing system;
decrypting said data on said data processing system;
classifying said data into a plurality of data fields;
entering additional data into said data processing system;
encrypting said data; and
transferring said additional data stored in said data processing system to said portable medical data storage unit device.

8. The method of claim 7, wherein said data fields are selectively segmented according to patient data, medical history data, alerts and medications data, notes data, and images data.

9. The method of claim 7, wherein said portable medical data storage unit device comprises:
a data storage component operable for storing said data fields, wherein said data fields are readable and writeable by a user;
a universal serial bus port;
a housing unit adapted to house said data storage component and said universal serial bus port; and
connecting means configured on said housing unit for attaching to an external receptor.

10. The method of claim 9, wherein said housing unit is flame retardant.

11. The method of claim 9, wherein said housing unit is water resistant.

12. The method of claim 7, wherein said data comprises images.

13. The method of claim 12, wherein said images comprise photographic, x-ray, graphical, text, and color images.

14. The method of claim 7, further comprising:
sending an authorization inquiry to an external information system; and
receiving one of a positive and negative response from said external information system.

15. The method of claim 7, further comprising:
sending a verification inquiry to an external information system; and
receiving one of a positive and negative response from said external information system.

16. A program storage device readable by machine, tangibly embodying a program of instructions executable by said machine to perform a method of managing medical data, said method comprising:
attaching a portable medical data storage unit device to a data processing system through a universal serial bus port interface, wherein said portable medical data storage unit device stores said data;
reading said data on said data processing system;
decrypting said data on said data processing system;
classifying said data into a plurality of data fields;
entering additional data into said data processing system;
encrypting said data; and
transferring said additional data stored in said data processing system to said portable medical data storage unit device.

17. The program storage device of claim 16, wherein said data fields are selectively segmented according to patient data, medical history data, alerts and medications data, notes data, and images data.

18. The program storage device of claim 16, wherein said portable medical data storage unit device comprises:
a data storage component operable for storing said data fields, wherein said data fields are readable and writeable by a user;
a universal serial bus port;
a housing unit adapted to house said data storage component and said universal serial bus port; and
connecting means configured on said housing unit for attaching to an external receptor.

19. The program storage device of claim 18, wherein said housing unit is flame retardant.

20. The program storage device of claim 18, wherein said housing unit is water resistant.

21. The program storage device of claim 16, wherein said data comprises images.

22. The program storage device of claim 21, wherein said images comprise photographic, x-ray, graphical, text, and color images.

23. The program storage device of claim 16, wherein said method further comprising:
sending an authorization inquiry to an external information system; and
receiving one of a positive and negative response from said external information system.

24. The program storage device of claim 16, wherein said method further comprising:
sending a verification inquiry to an external information system; and
receiving one of a positive and negative response from said external information system.

25. A health information management system comprising:
storage means for storing data fields, wherein said data fields are readable and writeable by a user;
interface means for transmitting said data fields to a display mechanism;
a portable housing unit adapted to house said storage means and said interface means; and
connecting means configured on said housing unit for attaching to an external receptor,
wherein said display mechanism receives said data fields from said interface means, said display mechanism operable to display said data fields into a readable format for said user.

26. The system of claim 25, wherein said data fields comprise data further comprising patient information, medical history information, alerts and medications information, notes information, and images information fields.

27. The system of claim 25, wherein said portable housing unit is flame retardant.

28. The system of claim 25, wherein said portable housing unit is water resistant.

29. The system of claim 26, wherein said data comprises images.

30. The system of claim 29, wherein said images comprise photographic, x-ray, graphical, text, and color images.
